(19) United States
(12) Patent Application Publication
(10) Pub. No.: US 2010/0323181 A1
(43) Pub. Date: Dec. 23, 2010

(54) RIGID CARBON FIBER CORES FOR SANDWICH COMPOSITE STRUCTURES

(76) Inventors: Steven R. Nutt, Irvine, CA (US); Yi-Jen Huang, Taipei (TW)

Correspondence Address: FISH & RICHARDSON P.C. (SD), P.O. BOX 1022, MINNEAPOLIS, MN, 55440-1022, US

(21) Appl. No.: 12/819,151

(22) Filed: Jun. 18, 2010

Related U.S. Application Data
(60) Provisional application No. 61/219,714, filed on Jun. 23, 2009.

(51) Int. Cl. B32B 1/04; B23P 17/00

(52) U.S. Cl. 428/221; 29/527.2

(57) ABSTRACT

Described are Rigid fiber cores such as carbon fiber cores for sandwich composite structures. The carbon fiber cores may be fabricated into various truss configurations including pyramidal lattice truss. The carbon fiber cores may be filled with foams for enhanced mechanical performance.

### CLAIM OF PRIORITY

This application claims priority under 35 USC §119(e) to U.S. Patent Application Ser. No. 61/219,714, filed on Jun. 23, 2009, the entire contents of which are hereby incorporated by reference.

### BACKGROUND

This application relates to composite material structures, including structure configurations with light weight, high stiffness and high strength.

Composite material structures are artificial composite structures that are designed to achieve certain material and structural properties that are superior to natural materials and other artificial materials. Examples of composite material structures include core materials in sandwich structures which can be in form of polymer foams or cellular honeycombs of paper, plastic, metal or other materials. Composite material structures can be used a wide range of applications.

### DESCRIPTION OF DRAWINGS

FIGS. 1(a)-1(d) show four types of trusses that can be used to couple face sheets: (a) octet truss, (b) tetrahedral lattice truss, (c) pyramidal lattice truss and (d) 3D kagome.

FIG. 2 shows an exemplary mold that can be used to prepare rigid carbon fiber cores.

FIG. 3 shows an exemplary rigid carbon core with phenolic foam.

FIG. 4 shows an exemplary rigid truss that can be produced from carbon fiber towpreg.

FIG. 5 shows an exemplary normal pyramidal unit cell model.

FIG. 6 shows an exemplary coordinate system.

FIG. 7 shows compressive stress-strain response for four exemplary sandwich samples.

FIG. 8 shows shear stress-strain response for four exemplary sandwich samples.

FIG. 9 shows a process flow diagram of a process for forming a 3D truss structure.

### SUMMARY

Systems and techniques for rigid cores for sandwich structures are provided where pre-impregnated carbon fiber tows (towpreg) may be configured to produce truss structures such as 3D pyramidal truss structures for use as cores for sandwich panels. Despite the curvature of the trusses, the specific compressive strength and modulus values of the truss cores can be greater than commercial aluminum honeycombs, while the specific shear strength and modulus can be comparable to aluminum honeycomb panels. The composite truss cores can show load-carrying abilities after peak shear strength. Foams may be injected into the truss cores so as to provide mechanical support to the trusses, thereby giving synergistic effects for enhancing the capacity to carry compressive and shear loads.

In one aspect, an engineering structure includes a rigid carbon fiber core to form a 3D truss structure comprising beams arranged in triangular configurations to carry tensile and compressive loads when the 3D truss structure is subject to bending or shear loading.

Implementations can optionally include one or more of the following features. The rigid carbon fiber core can include carbon fibers impregnated with epoxy and partly cured to a tacky state. The rigid carbon fiber core can be configured into a pyramidal truss. The rigid carbon fiber core can be configured into an octet truss. The rigid carbon fiber core can be configured into a tetrahedral lattice truss. The rigid carbon fiber core can be configured into a 3D kagome truss. The rigid carbon fiber core can include a foam material. The rigid carbon fiber core can be fabricated using 3D textile technology.

In another aspect, a method of generating an engineering structure includes forming a carbon fiber towpreg material, which can include impregnating carbon fiber material with epoxy, and curing the impregnated carbon fiber material. The method can include building a 3D truss structure using the formed carbon fiber towpreg material using a tool made of multiple orthogonal rods at two different heights. Building the 3D truss structure can include weaving or wrapping the carbon fiber towpreg over and under the rods of the tool in orthogonal directions to configure the 3D truss structure, curing the configured 3D truss structure, and removing the rods from the cured 3D truss structure.

Implementations can optionally include one or more of the following features. Building the 3D truss structure can include controlling the final configuration of the 3D truss structure by adjusting the elevation and spacing of the rods in the tool. The method can include building multiple 3D truss structures, each with different densities. The method can include using the 3D truss structure to form a sandwich composite structure. The method can include filling an interstitial space between multiple 3D truss structures with foam. The rigid carbon fiber core can be configured into a pyramidal truss. The rigid carbon fiber core can be configured into an octet truss. The rigid carbon fiber core can be configured into a tetrahedral lattice truss. The rigid carbon fiber core can be configured into a 3D kagome truss. The rigid carbon fiber core can include a foam material. The rigid carbon fiber core can be fabricated using 3D textile technology.

In another aspect, a sandwich composite structure includes a rigid carbon fiber core to form a 3D truss structure comprising beams arranged in triangular configurations to carry tensile and compressive loads when the 3D truss structure is subject to bending or shear loading.

Implementations can optionally include one or more of the following features. The sandwich composite structure of claim can be configured to have specific properties that are comparable to commercial grade honeycombs.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DETAILED DESCRIPTION

In the design of engineering structures for aerospace and transportation applications, minimized weight can be a design consideration and/or constraint. In such applications, it may be desirable that load-bearing components be lightweight and compact. As such, lightweight materials can be enablers for transportation vehicles, where reduced vehicular weight may improve fuel efficiency.

Sandwich concept is a well-established construction technique that combines low weight with high stiffness and strength. Sandwich structures can be suitable for a wide range of weight-sensitive applications, ranging from packaging, such as corrugated cardboard, to aircraft flooring made from honeycomb panels. Sandwich structures, particularly composite sandwich structures, may deliver acceptable performance in aerospace, transportation, and marine applications.

Complex components manufactured from laminates can have relatively high cost, joining challenges, and susceptibility to moisture uptake and impact damage. Conventional core materials used in sandwich structures may be either polymer foams or cellular honeycombs of paper, plastic, or metal. Polymer foams and cellular honeycombs can sustain damage through in-plane shear, core compression failure, and face sheet debonding. Sandwich structures can suffer damage from impacts caused by accidental dropping of objects, vehicular collisions, or foreign object collisions that may occur during the life of the structures. Such impacts can lead to internal damage that may be difficult to detect, thereby compromising the strength and stability of the structures. Also, impact loads may cause local delamination of face sheets in the structures, which can also be difficult to detect and repair.

Core materials reinforced through the thickness with 3D fiber architectures or z-direction reinforcements can be used to fabricate composite structures. 3D fabrics may provide resistance to delamination and damage from an impact load by mechanical linkage to the face sheets. In the composites fabricated, damage tolerance and impact resistance may be increased as a result of the through-thickness fiber reinforcement of the cores, and in some cases, the mechanical interlocking provided by fibers woven into the face sheets and extending through the cores.

3D composites can be produced using various techniques such as stitching and z-rods (z-pinning). For example, 3D composites can be manufactured by textile techniques of weaving, braiding, stitching, and knitting. 3D composite structures made with 3D textile fabrics can be less expensive to manufacture and may provide better through-the-thickness mechanical properties than composites made with traditional 2D fabrics. 3D woven composite structures may require in situ core formation, which can result in low quality core materials. Z-pinning can be a slow and expensive process that may only be suitable for aerospace market.

As an alternative technique to 3D weaving and z-pinning, through-thickness stitching of foam cores and 3D composite laminates can be used to make 3D composites. Stitching can involve sewing high-tensile strength yarn (e.g. glass, carbon or Kevlar), through an uncured prepreg laminate or dry fabric plies using an industrial sewing machine. Stitching can increase interlaminar properties, thereby enhancing the delamination resistance and the compression strength after impact of polymeric-matrix composite laminates. As such, stitching can be effective in reducing delamination damage to composites subjected to low-velocity, lightweight impact loadings. The translaminar strength of fiber reinforced polymer (FRP) composites can also be improved by stitched reinforcement with high-tensile-strength fibers such as Kevlar. During stitching of prepreg laminates, the tackiness of the uncured resin may make sewing difficult and some of the in-plane fibers can be broken and/or distorted by the stitching. This damage may affect the mechanical properties of stitched laminates.

This document provides systems and techniques for core structures that are suitable for use in sandwich structures. The core structures provided herein can be both affordable and impact resistant. The core structures provided herein can offer mechanical efficiency that is comparable to conventional core materials used in aircraft, marine or transportation vehicles.

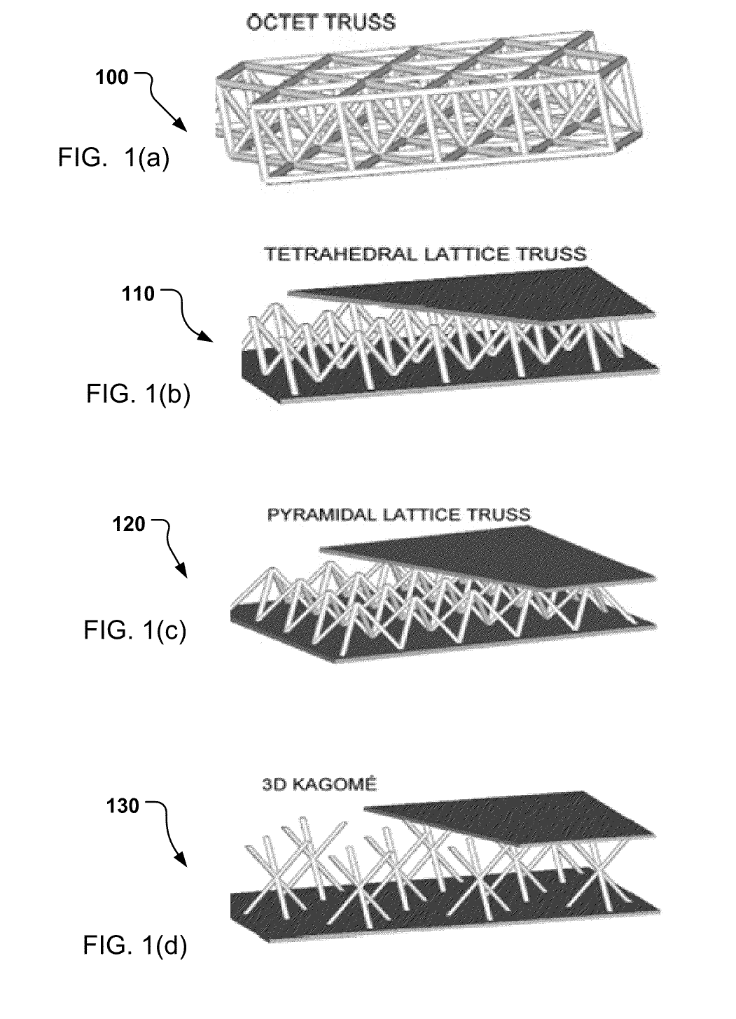

In some embodiments, pre-impregnated or pregreg carbon fiber tows (towpreg) can be used to build a 3D truss structure to serve as the core of a sandwich panel. This 3D structure can resemble a conventional macroscopic truss structure in which the composite trusses may carry tensile and compressive loads when the structure is subject to bending or shear loading. A truss structure can include beams arranged in triangular configurations that may be used in building construction for mechanical efficiency. FIGS. 1(a)-(d) show four types of truss structures (i.e., octet truss 100, tetrahedral lattice truss 110, pyramidal lattice truss 120 and 3D kagome 130) that can be used to couple face sheets. In FIG. 1(a), the octet truss 100 can be considered as a face-centered cubic lattice where points are uniformly distributed and have equal distances between each point and its 12 nearest neighbors. In FIG. 1(b), the tetrahedral lattice truss 110 can be a simple structure with equal-length bars. In FIG. 1(c), the pyramidal lattice 120 truss can be a structure with repeating pyramids standing side-by-side. Truss lattices may be employed in large spacecraft due to their high stiffness and light weight.

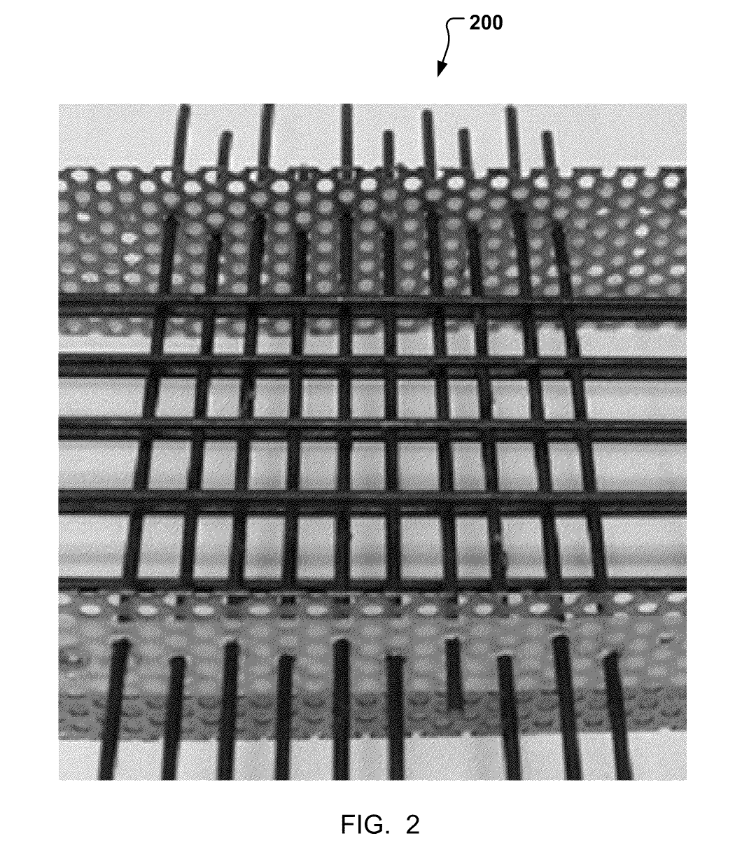

In some embodiments, the pyramidal lattice truss 120 can be used due to the ease of processing and the relatively lighter weight compared to other truss configurations. Fiber towpregs such as carbon fiber towpreg can be used to build the truss structure. The carbon fiber towpreg can include carbon fibers that may be impregnated with epoxy and partly cured to a tacky state. FIG. 2 shows a mold 200 that can be used to make pyramidal lattice trusses.

Compared to other core materials, the rigid carbon fiber truss structures provided herein can have an advantage in cost and/or in mechanical performance. Compared to honeycombs, the rigid carbon fiber cores provided herein can be easier to manufacture and can show better compressive strength, while the density of the cores can be as low as about 5 pcf. The compressive strengths of a carbon fiber core and two commercial honeycombs are shown in the Table 1. A comparison of a carbon fiber core to two commercial PVC foams is shown in Table 2.

TABLE 1
Compressive strengths of a carbon fiber
core and two commercial honeycombs

| | Rigid Carbon Fiber | | |
|---|---|---|---|
| Sample | Core | Gillfab 4030^{a} | Gillfab 4014^{a} |
| Density | ~5.0 pcf | 5.7 pcf | 4.3 pcf |
| Compressive | ~4.4 MPa | 4.1 MPa | 2.8 MPa |
| Strength | | | |

^{a}Data obtained from M. C. Gill Corporation data sheet.

TABLE 2
Comparison of a carbon fiber core to two commercial PVC foams

| | Rigid Carbon Fiber | Divinycell | Divinycell |
|---|---|---|---|
| | Core | H Grade^{a} | HP Grade^{a} |
| Compressive | ~4.4 | 1.4 | 1.5 |
| Strength (MPa) | | | |
| Compressive | ~101 | 90 | 105 |
| Modulus (MPa) | | | |
| Shear Strength | ~1.17 | 1.15 | 1.25 |
| (MPa) | | | |
| Shear Modulus | ~6.83^{b} | 27 | 28 |
| (MPa) | | | |

^{a}Data obtained from DIAB data sheet.
^{b}Low shear modulus due to truss curvature. Stiffer in shear expected for straight trusses that can be made with Kevlar or polymeric fibers.

As described above, the 3D textile technology used to fabricate the sandwich cores may involve arranging fiber towpreg in a desired configuration, then curing, usually with heat. When compared to stitching technology, the manufacturing process described herein may cause substantially no destruction of surrounding materials and may enable a wider selection of face sheet materials.

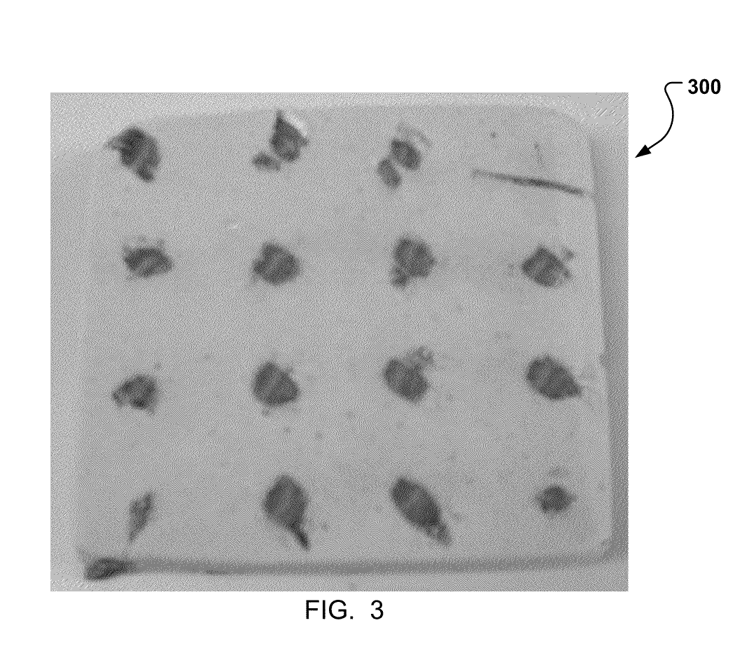

The truss core concept can be combined with other core types. For example, if a foam core is selected for a sandwich panel (to impart thermal or acoustic insulation, for example), foam can be injected and expanded within a composite truss core. In some embodiments, a composite truss core can be prepared, following by injecting the core with phenolic foam. FIG. 3 shows exemplary rigid carbon core with phenolic foam 300 produced by this process. Any type of face sheets can be used as skin for the core to make a sandwich structure, so long as the face sheets used can be bonded to the core.

In some embodiments, the manufacturing process described herein can include implementation of more advanced textile technology, selection of different fibers with greater bending flexibility, local reinforcement of core/skin contact, and higher volume fractions of fibers. The application of more advanced textile technology may enable faster and less expensive manufacturing, as well as more precise location and placement of fiber towpregs. The use of fibers with greater bending flexibility in a higher volume fraction may improve the compressive and tensile properties of each truss element within the core.

In some implementations, carbon fiber towpreg (Panex 35 continuous tow) can be used to build a truss core. The towpreg may include carbon fibers (˜55 vol %) impregnated with epoxy and partly cured to a tacky state. The mold 200 used to form the truss structure is shown in FIG. 2. The mold can include multiple orthogonal rods at two different heights. The rods can be removed after curing. The final configuration of the truss may be controlled by adjusting the elevation and spacing of the rods in the mold. After setting the rods, the towpreg can woven or wrapped over and under the rods in orthogonal directions. Once configured, the assembly can be cured in an oven at 110° C. for 4 hours. After curing, the rods can be removed, followed by removing the truss structure from the mold.

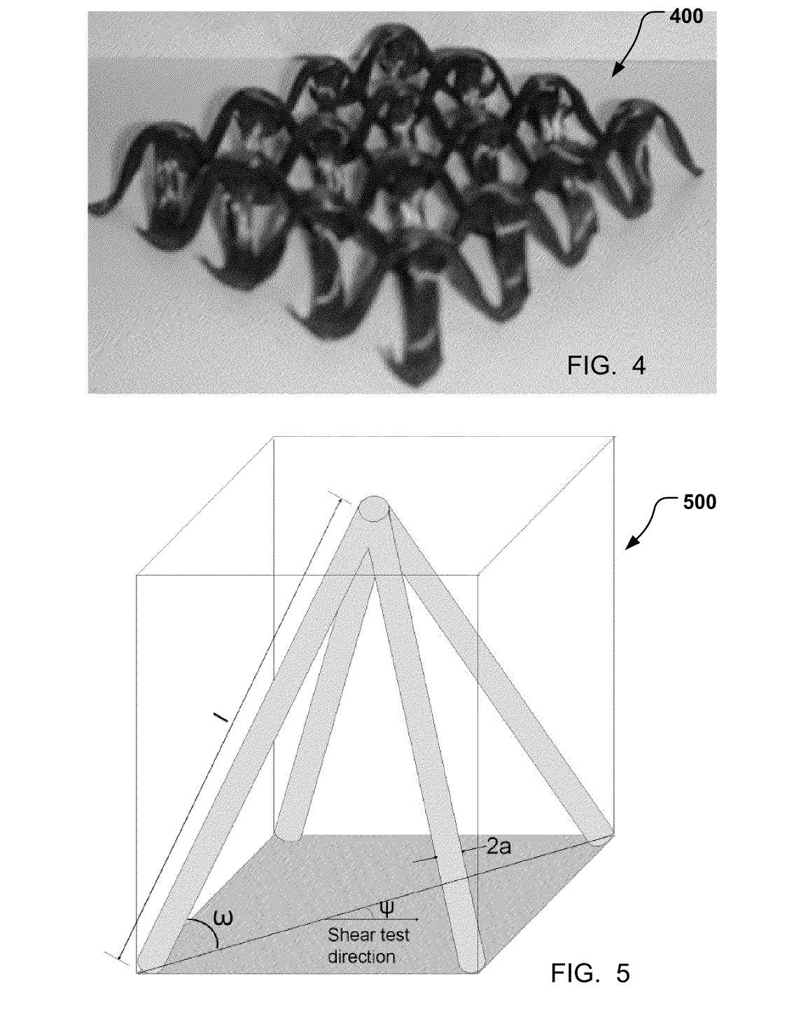

FIG. 4 shows a typical sample rigid carbon fiber core 400 produced by this process. The truss elements of the sample may have curvatures. Cores with two relative densities may be prepared: ˜80 kg/m³ and ˜40 kg/m³. Sandwich beams can be fabricated using aluminum sheets 0.508 mm thick. Foam-filled truss cores can be fabricated using heat expandable PVC foam with a density of ˜48 kg/m³. The foam may be made from heat expandable microspheres (Expancel DU 461). The foam may fill the interstitial spaces between the truss elements. The shear strength of the foam is about 0.35 MPa, and the shear modulus of the foam is about 6 MPa.

Four types of sandwich samples may be prepared: Sample 1 can be a sandwich beam with a high-density truss core (a relative density of ˜80 kg/m³); Sample 2 can be a sandwich beam with a foam-filled high-density truss core; Sample 3 can be a sandwich beam with a low-density truss core (a relative density of ˜40 kg/m³); and Sample 4 can be a sandwich beam with a foam-filled low-density truss core.

The slenderness ratio of the struts (length-to-radius) is about 21.05 for Samples 1 and 2, and the slenderness ratio is about 29.65 for Samples 3 and 4.

The macroscopic relative density for the composite truss cores (obtained by weighing the truss cores and measuring the bulk volume) is about 0.044 (˜83 kg/m3) for Samples 1 and 2, and about 0.022 (˜41 kg/m3) for Samples 3 and 4.

The sandwich samples can be tested in compression and shear in accordance with standard protocols (ASTM C-365 and ASTM C-273). The loading rate may be 10⁻³/s. The compression samples may be 40 mm×40 mm×15.6 mm, while the shear samples may be 40 mm×320 mm×15.6 mm. Five replicates can be tested for each sample type.

Unit Cell Architecture and Relative Density

A regular pyramidal can include a quadrilateral base with triangular side surfaces joined at one point. However, unlike regular pyramid, the struts of composite truss cores are curved at the nodes where they joined. This can be a consequence of the cylindrical rods in the tool, and the limited formability of the CF towpreg, as discussed previously. Nevertheless, the relative density of the structures can be calculated by starting with a normal pyramidal model 500 and assuming straight struts with length l and radius a as shown in FIG. 5. Equation (1) below shows the geometric computation dictating the relative density of the core:

$$ρ = \frac{4 π {a}^{2} l}{{( \sqrt{2} l cos ω )}^{2} l sin ω} = \frac{2 π}{{cos}^{2} ω sin ω} {( \frac{a}{l} )}^{2} \qquad ( 1 )$$

The effective truss angles and lengths were determined to be ω=48° and strut length 1=21.05 mm. For Samples 1 and 2, the strut radius r was 1 mm, resulting in a relative (macro) density for the composite truss core of 0.043. For Samples 3 and 4, the strut radius was 0.71 mm, and the relative density of the composite truss core was 0.022. The macroscopic relative density for the composite truss cores (obtained by weighing the truss cores and measuring the bulk volume) was 0.044 (83 kg/m3) for Samples 1 and 2, and 0.022 (41 kg/m3) for Samples 3 and 4.

Analytical Prediction of the Pyramidal Truss Core Response

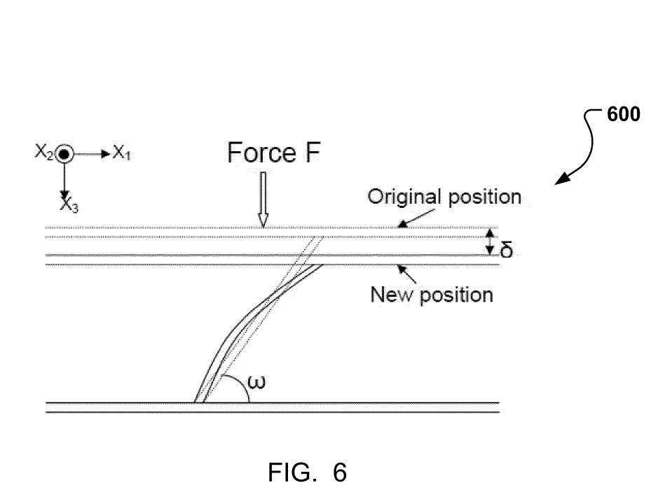

A simple analysis was used to predict the stiffness and strength of the truss cores. Based on the coordinate system 600 in FIG. 6, analytical expressions for the out-of plane axial stiffness E₃₃, strength σ₃₃, the transverse shear stiffness G₁₃, and the strength σ₁₃ of the pyramidal core can be obtained in terms of the core geometry and the elastic properties of the truss material. The properties of the core can be evaluated by focusing on the elastic deformation of a single strut resulting from an applied force.

In FIG. 6, the fixed edge cylindrical strut of length l and radius a represents a single strut of the pyramidal core. Originally, the faces embedded in the core in a fixed position drawn in the FIG. 6. Application of force F displaces the face to a new position such that the top end of the strut moves freely along the x₃-direction, but is fixed in the x₁ and x₂-directions. The imposed displacement δ is generated by the applied force F, which is comprised of the axial force F_{A} and the shear force F_{S}. The F_{A} and F_{S} are given by elementary beam theory as

$$\begin{matrix}{F}_{A} = {E}_{S} π {a}^{2} \frac{δ sin ω}{l} & ( 2 ) \\ {F}_{S} = \frac{12 {E}_{S} I δcos ω}{{l}^{3}} & ( 3 )\end{matrix}$$

where I≡πa⁴/4 is the second moment of area of the strut cross-section, and E_{S} is the Young's modulus of a single carbon fiber strut. The total applied force F in the x₃-direction follows as

$$F = {F}_{A} sin ω + {F}_{S} cos ω = \frac{{E}_{S} π {a}^{2} δ}{l} [ {sin}^{2} ω + 3 {( \frac{a}{l} )}^{2} {cos}^{2} ω ] \qquad ( 4 )$$

Referring back to FIG. 5, there are four struts in a unit cell 500. The out-of plane axial stress σ33 and strain c applied to the unit cell are related to the force F and displacement δ via

$$\begin{matrix}{σ}_{33} = \frac{8 F}{{( 2 l cos ω )}^{2}} = \frac{2 F}{{l}^{2} {cos}^{2} ω} & ( 5 ) \\ ɛ ≡ \frac{δ}{l sin ω} & ( 6 )\end{matrix}$$

The effective Young's modulus can be obtained from equations (5) and (6) as

$$\begin{matrix}\frac{{E}_{33}}{{E}_{S}} = \frac{2 π sin ω}{{cos}^{2} ω} {( \frac{a}{l} )}^{2} [ {sin}^{2} ω + 3 \frac{{cos}^{2}}{{( \frac{l}{a} )}^{2}} ] \\ = ρ {sin}^{4} ω + \frac{3 {ρ}^{2}}{2 π} {sin}^{3} ω {cos}^{4} ω\end{matrix} \qquad ( 7 )$$

The first and second terms in equation (7) represent the contributions to the stiffness of the pyramidal core due to the stretching and bending of the struts, respectively.

Wallach and Gibson analyzed the stiffness and strength of a pyramidal truss core and reported approximate analytical expressions for the shear modulus, compressive strength, and shear strength. Assuming the pyramidal truss core is sufficiently symmetric that the transverse shear modulus is isotropic,

$$\frac{{G}_{13}}{{E}_{S}} = π sin {ω ( \frac{a}{l} )}^{2} = \frac{ρ}{8} {sin}^{2} 2 ω \qquad ( 8 )$$

Ideally, all four bars yield simultaneously, and the normal collapse strength σ₃₃ under compressive load is

$$\frac{{σ}_{33}}{{σ}_{Y}} = 2 π \frac{sin ω}{{cos}^{2} ω} {( \frac{a}{l} )}^{2} = ρ {sin}^{2} ω \qquad ( 9 )$$

where σ_{Y} is the yield strength of the carbon fiber strut. The transverse shear strength σ₁₃ depends on the loading direction ψ as defined in FIG. 5. The yield surface consists of several collapse planes, each plane corresponding to two struts undergoing tensile yield and two undergoing compression yield. Thus, the shear strength τ(ψ) is given by

$$\frac{τ ( ψ )}{{σ}_{Y}} = \frac{2 π}{cos ω} \frac{1}{( cos ψ + sin ψ )} {( \frac{a}{l} )}^{2} = \frac{ρ}{2} \frac{sin 2 ω}{( cos ψ + sin ψ )} \qquad ( 10 )$$

for |ψ|≦π/4. For the composite truss cores fabricated here, the angle ψ was 45°. Based on the compression test on carbon fiber rods, the yield strength and the Young's modulus of a single carbon fiber strut were 350 MPa and 10 GPa, respectively. Substituting these two values (σ_{Y} and E_{S}) into equations (7)˜(10), the calculated values are listed in Table 3 for compressive responses and Table 4 for shear responses.

TABLE 3
Compressive Responses

| | Stress (MPa) | Modulus (MPa) |
|---|---|---|
| Prediction | 8.23 | 130 |
| Sample 1 | 4.61 ± 0.37 | 72 ± 9 |
| Sample 2 | 5.39 ± 0.43 | 94 ± 12 |
| Prediction | 4.12 | 65 |
| Sample 3 | 2.46 ± 0.17 | 42 ± 5 |
| Sample 4 | 2.72 ± 0.19 | 51 ± 5 |

The ratios of measured compressive strength-to-predicted strength were 0.57 and 0.60 for Samples 1 and 3, respectively. Similarly, the ratios for the experimental to predicted values for compressive modules were 0.55 and 0.65 for Samples 1 and 3. The fact that measured values were approximately 0.6 of predicted values was attributed to the curvature of the struts. Note that the predictions assume a simplified geometry characterized by straight struts. The curved struts were effectively pre-bent, resulting in a reduced plastic buckling strength. As expected, the addition of heat expandable foam enhanced both compressive strength and modulus of the truss core, resisting strut bending and buckling. Comparing Sample 1 and 2, the latter showed a 16% increase in strength and a 31% increase in modulus.

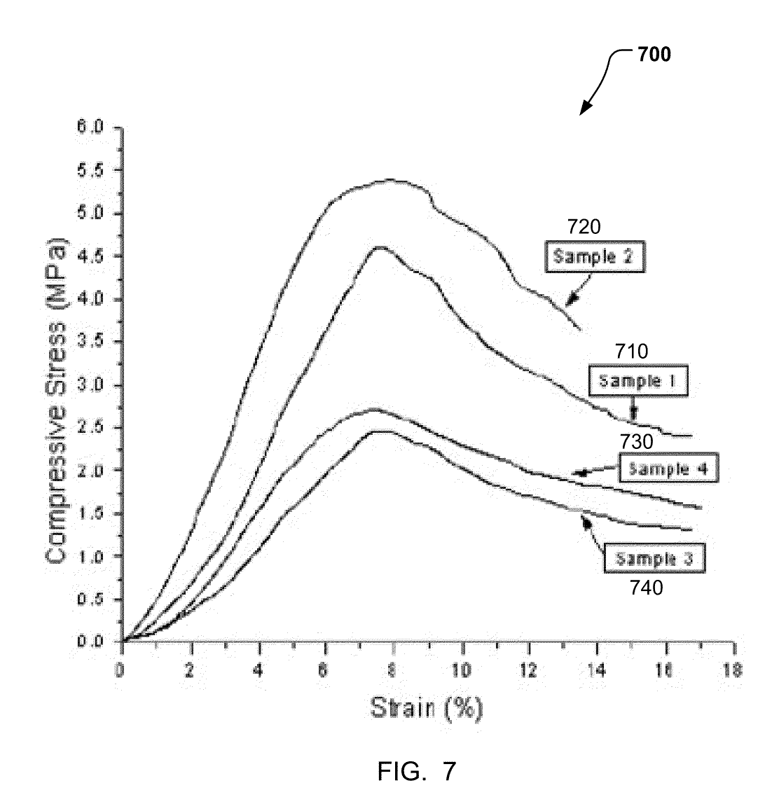

The corresponding stress-strain response is plotted in FIG. 7. In all four cases, an initial linear response was observed, followed by nonlinear regime in which the slope decreased continuously. After a broad peak, the stress decreased with increasing strain. The peak stress was reached at a strain of ˜7% in all four samples. The nonlinear regime corresponded to plastic buckling of the struts in the pyramidal core specimens. The truss core failure mechanism (elastic or plastic buckling or plastic yield) depended on the slenderness ratio of the struts (length-to-radius). The slenderness ratio was 21.05 for Samples 1 and 2, and the slenderness ratio was 29.65 for Samples 3 and 4. Because the slenderness ratio and relative density of the truss core are interdependent, both factors affect the truss core strength, and the failure mechanism (as well as the truss material).

Shear Response

The shear strength and modulus values for the four composite truss samples are listed in Table 4, along with the analytical predictions. Sample 2, with the highdensity foam-filled truss core, showed the highest shear strength and modulus values (2.78 and 50 MPa) of the four samples. The high-density truss core exhibited higher shear strength and modulus compared to the low-density core (compare Samples 1 and 3). The ratios of measured-to-predicted values for shear strength were 0.43 and 0.44 for Samples 1 and 3, while the ratios for shear modulus values were 0.78 and 0.68. As before, the differences between the predicted and measured values were attributed to the truss curvature.

TABLE 4
Shear Responses

| | Stress (MPa) | Modulus (MPa) |
|---|---|---|
| Prediction | 5.25 | 52.7 |
| Sample 1 | 2.28 ± 0.17 | 41 ± 4 |
| Sample 2 | 2.78 ± 0.19 | 50 ± 6 |
| Prediction | 2.63 | 26.4 |
| Sample 3 | 1.15 ± 0.06 | 18 ± 2 |
| Sample 4 | 1.60 ± 0.09 | 25 ± 2 |

The addition of heat expandable foam caused increases in shear strength and modulus of the truss-core sandwich structures (see Table 2). Relative to the unfilled truss core (Sample 3), Sample 4 showed increases in shear strength and modulus of 39% and 38%. The foam lent support to the trusses, resisting bending and buckling. The shear strength of the foam was only 0.35 MPa, and the shear modulus of the foam was 6 MPa. The shear strength values of the foam-filled truss cores were 6% greater than the mere sum of the two, indicating a modest synergistic effect. (Note that the in-plane shear modulus for these samples did not exhibit simple Rule of Mixtures behavior because the shear modulus was dominated by the CF trusses.)

The measured shear stress-strain curves for the pyramidal cores are shown in FIG. 6. The samples exhibited characteristics of truss-based sandwich cores [26], including elastic behavior during initial loading, which continued as the load increased until a peak stress was reached. The peak stress was followed by a brief stress plateau, after which the load decreased sharply. The shear strength of the truss cores depended on the initial failure mode of the truss members. In shear, two struts in each unit cell are loaded in compression and two in tension. Mechanics-based simulations predict that failure of such truss structures are most likely to initiate by buckling of the struts loaded in compression [27]. After the buckling of the compression-loaded struts, the tension struts continued to carry load until the onset of rupture of the nodes. Continued loading produced a stress plateau, the duration (or net strain) for which was markedly different between samples with or without foams (compared Samples 1 and 2). The presence of foams extended the stress plateau by providing added support to trusses in the core, resisting buckling and the initiation of failure. Note that the load shed by the ruptured trusses redistributed to neighboring, intact struts, and some of the load was transferred via the foam. This robustness in the presence of failed struts is a key attribute of the pyramid truss configuration.

Compressive Response

Sandwich samples with aluminum face sheets and the pyramidal truss cores having sixteen pyramidal unit cells can be used in compression tests. Two samples with unfilled pyramidal truss cores, with relative densities of ˜80 kg/m³ and ˜40 kg/m³, may be tested. Similar samples featuring truss cores filled with heat expandable PVC foam (density of ˜48 kg/m³) may also be tested and compared with the samples with unfilled cores. The compressive strength and modulus of the four samples are listed in Table 5. The compressive strengths for the samples with high-density truss cores, Samples 1 and 2, are about 4.61 MPa and about 5.39 MPa, respectively, while the compressive moduli are about 72 MPa and about 94 MPa. The compressive strengths for the samples with low-density truss cores, Samples 3 and 4, are about 2.46 MPa and about 2.72 MPa, respectively, while the compressive moduli are about 42 MPa and about 51 MPa. Sample 2, with the high-density truss core and heat expandable foam, shows the highest compressive strength (˜5.39 MPa) and modulus (˜94 MPa) of the four samples. The addition of heat expandable foam can enhance both compressive strength and modulus of the truss cores, resisting strut bending and buckling. Comparing Samples 1 and 2, Sample 2 shows a ˜16% increase in strength and a ˜31% increase in modulus. Comparing Samples 3 and 4, Sample 4 shows a ˜11% increase in strength and a ˜21% increase in modulus. The high-density truss cores can exhibit higher compressive strength and modulus compared to the low-density cores. Comparing Samples 1 and 3, the strength and modulus of Sample 1 are about 87% and about 71% higher than Sample 3. Comparing Samples 2 and 4, the strength and modulus of Sample 2 are about 98% and about 84% higher than Sample 2.

TABLE 6
Compressive responses for sandwich samples

| | Stress (MPa) | Modulus (MPa) |
|---|---|---|
| Sample 1 | 4.61 ± 0.37 | 72 ± 9 |
| Sample 2 | 5.39 ± 0.43 | 94 ± 12 |
| Sample 3 | 2.46 ± 0.17 | 42 ± 5 |
| Sample 4 | 2.72 ± 0.19 | 51 ± 5 |

FIG. 7 shows the compressive stress-strain response 700 for the four sandwich samples. For all four samples 710, 720, 730 and 740, an initial linear response can be observed, followed by nonlinear regime in which the slope may decrease continuously. After a broad peak, the stress can decrease with increasing strain. The peak stress is reached at a strain of ˜7% in all four samples.

The shear strength and modulus for the four composite truss samples are listed in Table 8. The shear strengths for the samples with high-density truss cores, Samples 1 and 2, are about 2.28 MPa and about 2.78 MPa, respectively, while the shear moduli are about 41 MPa and about 50 MPa. The shear strengths for the samples with low-density truss cores, Samples 3 and 4, are about 1.15 MPa and about 1.60 MPa, respectively, while the compressive moduli are about 18 MPa and about 25 MPa. Sample 2, with the high-density foam-filled truss core, shows the highest shear strength and modulus (˜2.78 and ˜50 MPa) of the four samples. The addition of heat expandable foam can enhance both shear strength and modulus of the truss cores. Comparing Samples 1 and 2, Sample 2 shows a ˜22% increase in strength and a ˜22% increase in modulus. Comparing Samples 3 and 4, Sample 4 shows a ˜39% increase in strength and a ˜39% increase in modulus. The shear strength and modulus of the foam-filled truss cores may be greater than the sum of the foam and the unfilled cores, indicating a synergistic effect. The high-density truss cores can exhibit higher shear strength and modulus compared to the low-density cores. Comparing Samples 1 and 3, the strength and modulus of Sample 1 are about 98% and about 128% higher than Sample 3. Comparing Samples 2 and 4, the strength and modulus of Sample 2 are about 74% and about 100% higher than Sample 2.

TABLE 8
Shear responses for sandwich samples

| | Stress (MPa) | Modulus (MPa) |
|---|---|---|
| Sample 1 | 2.28 ± 0.17 | 41 ± 4 |
| Sample 2 | 2.78 ± 0.19 | 50 ± 6 |
| Sample 3 | 1.15 ± 0.06 | 18 ± 2 |
| Sample 4 | 1.60 ± 0.09 | 25 ± 2 |

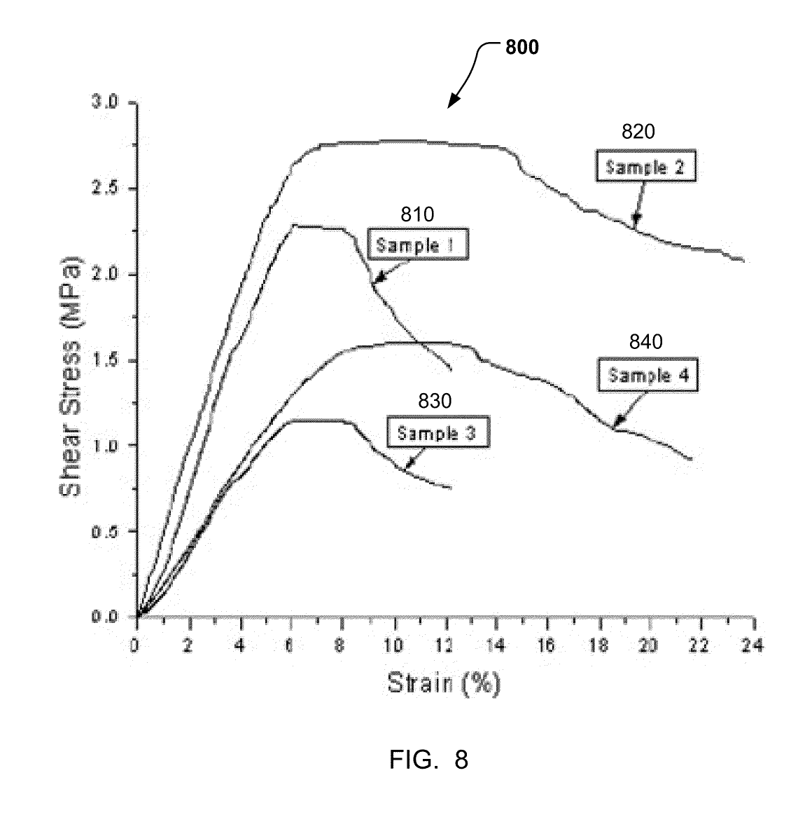

FIG. 8 shows the shear stress-strain response for the four sandwich samples 810, 820, 830 and 840. The samples can exhibit elastic behavior during initial loading, which may continue as the load increases until a peak stress may be reached. The peak stress can be followed by a brief stress plateau, after which the load can decrease sharply. The duration (or net strain) for the stress plateau can be extended by the addition of foams (compare Samples 1 and 2 & Samples 3 and 4) which may provide added support to trusses in the core, resisting buckling and the initiation of failure.

In Table 8, the specific strength and modulus of the sandwich beam with high-density composite truss cores (Sample 1) are compared to honeycomb sandwich panels, Gillfab 4030 and 4014, that are commonly used in aircraft interiors. Both sandwich panels feature aluminum facings bonded to aluminum honeycomb cores. The thickness of skins is the same for all samples. The specific compressive strength and modulus for Sample 1 are about 29% and about 17% greater than the commercial honeycombs. The specific shear strength and modulus for Sample 1 are about 21% and about 15% less than the Gillfab 4030 material. The specific properties of the truss cores provided herein can be generally comparable to conventional honeycombs.

TABLE 8
Specific properties of Sample 1 and commercial honeycombs

| | Sample 1 | Gillfab 4030 | Gillfab 4014 |
|---|---|---|---|
| Density (kg/m3) | 80 | 91.3 | 68.9 |
| Specific | 58 | 45 | 41 |
| Compressive | | | |
| Strength (KN- | | | |
| m/kg) | | | |
| Specific | 900 | 767 | 609 |
| Compressive | | | |
| Modulus (KN- | | | |
| m/kg) | | | |
| Specific Shear | 28 | 36 | 26 |
| Strength (KN- | | | |
| m/kg) | | | |
| Specific Shear | 512 | 602 | 406 |
| Modulus (KN- | | | |
| m/kg) | | | |

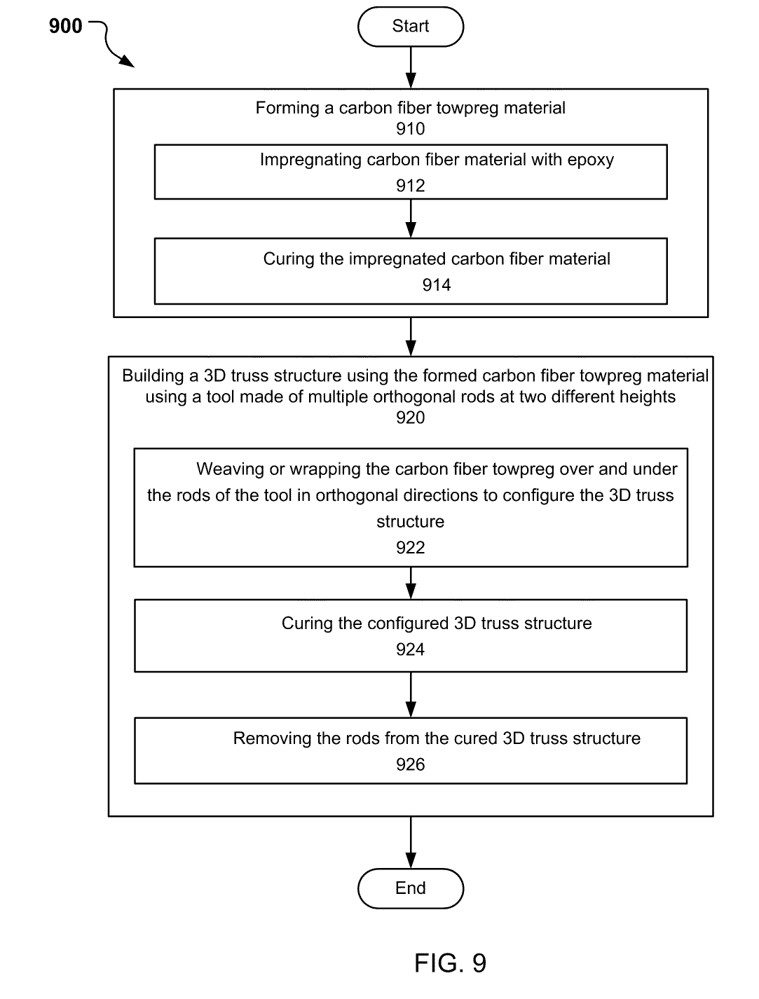

FIG. 9 shows a process flow diagram of a process 900 for forming an engineering structure, such as a 3D truss structure. A method of generating an engineering structure includes forming a carbon fiber towpreg material (910). Forming the carbon fiber towpreg material includes impregnating carbon fiber material with epoxy (912), and curing the impregnated carbon fiber material (914). The method can include building a 3D truss structure using the formed carbon fiber towpreg material using a tool made of multiple orthogonal rods at two different heights (920). Building the 3D truss structure can include weaving or wrapping the carbon fiber towpreg over and under the rods of the tool in orthogonal directions to configure the 3D truss structure (922). Building the 3D truss structure can include curing the configured 3D truss structure (924). Also, building the 3D truss structure can include removing the rods from the cured 3D truss structure (926).

Implementations can optionally include one or more of the following features. Building the 3D truss structure can include controlling the final configuration of the 3D truss structure by adjusting the elevation and spacing of the rods in the tool. The method can include building multiple 3D truss structures, each with different densities. The method can include using the 3D truss structure to form a sandwich composite structure. The method can include filling an interstitial space between multiple 3D truss structures with foam. The rigid carbon fiber core can be configured into a pyramidal truss. The rigid carbon fiber core can be configured into an octet truss. The rigid carbon fiber core can be configured into a tetrahedral lattice truss. The rigid carbon fiber core can be configured into a 3D kagome truss. The rigid carbon fiber core can include a foam material. The rigid carbon fiber core can be fabricated using 3D textile technology.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. An engineering structure, comprising:
a rigid carbon fiber core to form a 3D truss structure comprising beams arranged in triangular configurations to carry tensile and compressive loads when the 3D truss structure is subject to bending or shear loading.

2. The engineering structure of claim 1, wherein the rigid carbon fiber core comprises:
carbon fibers impregnated with epoxy and partly cured to a tacky state.

3. The engineering structure of claim 1, wherein the rigid carbon fiber core is configured into a pyramidal truss.

4. The engineering structure of claim 1, wherein the rigid carbon fiber core is configured into an octet truss.

5. The engineering structure of claim 1, wherein the rigid carbon fiber core is configured into a tetrahedral lattice truss.

6. The engineering structure of claim 1, wherein the rigid carbon fiber core is configured into a 3D kagome truss.

7. The engineering structure of claim 1, wherein the rigid carbon fiber core comprises a foam material.

8. The engineering structure of claim 1, wherein the rigid carbon fiber core is fabricated using 3D textile technology.

9. A method of generating an engineering structure, the method comprising:
forming a carbon fiber towpreg material comprising:
impregnating carbon fiber material with epoxy, and
curing the impregnated carbon fiber material; and
building a 3D truss structure using the formed carbon fiber towpreg material using a tool made of multiple orthogonal rods at two different heights, the building comprising:
weaving or wrapping the carbon fiber towpreg over and under the rods of the tool in orthogonal directions to configure the 3D truss structure,
curing the configured 3D truss structure, and
removing the rods from the cured 3D truss structure.

10. The method of claim 9, wherein building the 3D truss structure comprises:
controlling the final configuration of the 3D truss structure by adjusting the elevation and spacing of the rods in the tool.

11. The method of claim 9, comprising building multiple 3D truss structures, each with different densities.

12. The method of claim 9, comprising using the 3D truss structure to form a sandwich composite structure.

13. The method of claim 12, comprising filling an interstitial space between multiple 3D truss structures with foam.

14. The method of claim 9, wherein the rigid carbon fiber core is configured into a pyramidal truss.

15. The method of claim 9, wherein the rigid carbon fiber core is configured into an octet truss.

16. The method of claim 9, wherein the rigid carbon fiber core is configured into a tetrahedral lattice truss.

17. The method of claim 9, wherein the rigid carbon fiber core is configured into a 3D kagome truss.

18. The method of claim 9, wherein the rigid carbon fiber core comprises a foam material.

19. The method of claim 9, wherein the rigid carbon fiber core is fabricated using 3D textile technology.

20. A sandwich composite structure comprising:
a rigid carbon fiber core to form a 3D truss structure comprising beams arranged in triangular configurations to carry tensile and compressive loads when the 3D truss structure is subject to bending or shear loading.

21. The sandwich composite structure of claim 20 can be configured to have specific properties that are comparable to commercial grade honeycombs.
